(19) United States
(12) Patent Application Publication
(10) Pub. No.: US 2021/0154757 A1
(43) Pub. Date: May 27, 2021

(54) BAND SAW CUTTING EQUIPMENT

(71) Applicant: AMEBO FOOD MACHINERY, S.L., Cassà de la Selva (ES)

(72) Inventors: Raul PRIMO RUIZ, Polinyà (ES); Eduardo BOSCH DOMINGO, Cassà de la Selva (ES)

(21) Appl. No.: 17/053,473

(22) PCT Filed: May 6, 2019
(86) PCT No.: PCT/ES2019/070296

§ 371 Date: Nov. 6, 2020

(30) Foreign Application Priority Data
May 7, 2018 (ES) P201830449

(51) Int. Cl. B23D 55/08; B23D 53/00; B23D 55/06

(52) U.S. Cl. CPC B23D 55/082; B23D 55/065; B23D 53/005

(57) ABSTRACT

The present invention refers to a band saw cutting equipment used, preferably, for the cutting of frozen food products, which has a double band saw cutting system, both in the same cutting plane, with opposite serrated edges on the outside of the said cutting system and with a piece of guidance and separation of the two band saws, that allow the correct position of the band saw to be assured without it bending, maintaining the cutting plane and avoiding that it moves in the cutting plane, avoiding it leaving the pulley system, maintaining a minimum separation between the saws.

The present invention refers to a product cutting equipment, preferably for frozen food products, where the cutting is carried out by means of a band saw cutting system, preferably working in an automatic mode of product passage through the cutting system, although it can also be used in a manual mode of product displacement.

### BACKGROUND OF THE INVENTION

Product cutting equipment which has a band saw for the cutting of such products, where the band saw is usually driven by a system of motorised pulleys in which the band saw is installed, is known and, therefore, is in the state of the art. The band saw is guided and tensioned to prevent it from leaving the chosen position at the moment of cutting when the product exerts a force on the band saw.

The rotation of the pulleys allows the band saw to rotate at the speed of these pulleys, in such a way that by means of a serrated side on the side of the band saw where the product to be cut enters, the cutting of this product can take place, which is pushed in this direction, towards the serrated side of the band saw.

In order to cut the product, it has to be placed on the front of the band saw, to pass it through the band saw and cut a new portion of the product. Thus, for each new cut that needs to be made on the product, the product will make a return movement to the starting position of cutting as well as the movement by the band saw itself, so there are unproductive movements and unproductive time involved with the cutting machine.

There are also known band saws with double serrated edges, which allows them to cut on both sides, being able to make the cut in both directions, but which cannot be guided in the cutting plane, having saw serrated edges on both sides and not being able to counteract the thrust of the product when it is pressed against the saw band to make the cut. This lack of guidance causes a lack of safety in the position of the band saw, which can affect the precision of the cut of the product, as well as a possible exit of the band saw itself from the pulley system and therefore its malfunction, not being able to be used for the cutting of meat, fish, blocks, etc., whether frozen or not.

### DESCRIPTION OF THE INVENTION

The band saw cutting equipment obtained from the present invention resolves the cited drawbacks and has other advantages that will be described below.

The present invention is based on a cutting equipment based on cutting by band saws, so the equipment has the usual pulley systems for the movement of these band saws.

Advantageously, the cutting equipment contains at least one cutting system consisting of two individual band saws located adjacent to each other without touching each other, both on the same cutting plane, with this separation between the two individual band saws, each of these two band saws having a single side with cutting serrated edges located on the farthest opposite edges between the two band saws, in such a way that, when cutting a product and passing it through these band saws in any direction, the first edge they find will be serrated to make the cut of the product, while the inner edges closest between saws will not have cutting serrated edges.

The pressure on the band saws exerted by the passage of the product usually causes the movement of these band saws in the same cutting plane, especially if it involves frozen products, causing a possible contact of one saw against the other and, therefore, its possible deterioration, or could flex the band saws in the perpendicular plane, having different measures of cut product. For this reason, the cutting system of the equipment described in the present invention has at least one guide and separation piece of both band saws, having preferably two to four of these guide and separation pieces installed, where the separation piece is fixed in a position that guides each of the band saws in the cutting plane, preventing it from bending easily and leaving the said plane by means of guiding elements. In the same way, this guiding and separating piece keeps both band saws separated in the cutting plane by means of a minimum separating element.

The placement of these pieces of guide and separation allow to minimise the risk of exit of the saws from their position in the system of pulleys in which they rotate by the pressure action of the product to be cut, so they will preferably be placed on both sides of the cutting area, between this area and the next or previous pulley in such a way that the pressures in this area do not affect the correct passage of the band saws through the pulleys. This configuration of a separation piece on either side of the cutting area can be reinforced by placing more pieces on either side of the cutting area.

The separation between the band saws of the cutting system is introduced as a stop of the movement of the band saw that receives the pressure of the product to be cut in the cutting direction and to avoid the exit of its pulley wheel, as well as to avoid the contacts between these band saws by its non-serrated inner edges, with the minimum distance of the separation element being preferably less than 30 mm, and more preferably making the minimum between 2 mm to 6 mm, in such a way that, maintaining this distance between them, a greater separation could not give problems to the passage of the product to be cut through the second band saw, as the product can be turned towards the second cutting saw, although higher separations could be obtained with systems of separation of the cut product.

The products to be cut are preferably passed automatically by means of a gripping and displacement system of the product to be cut. The product can be of different dimensions in such a way that the cutting area of band saws can be more or less wide. Thus, to keep the cutting plane as fixed as possible, preferably, the cutting equipment has at least two pieces of guidance and separation of both band saws, each of them being located on each side of the cutting area of the product, being able to regulate the height of the position of at least one of the two pieces of guidance and separation that define the cutting area where the product passes.

The cutting equipment can incorporate, preferably in its automatic mode of use, a protective system of the band saws formed by a surrounding structure of these band saws that automatically moves to cover the cutting area when an operator enters the area of protected influence, with the aim of preventing the operator accidentally introducing some part of their body in the cutting area or that a break in the band saw at that time can come out and affect them, in addition to protecting the band saw itself from possible incidents of materials carried by the operator.

Also, preferably, the cutting equipment has a cleaning system of the band saws which eliminates the possible substances or residues of the cut of the product that can accumulate habitually in the cutting serrated edges, with the effectiveness of this cut being able to be reduced.

The cutting equipment can be configured to multiply the cutting systems available in the same equipment in a similar way to that indicated above. Simultaneous cuts can be made in parallel planes, having two or more cutting systems that make these cuts in parallel planes.

This advantageous configuration in two band saws per cutting system installed on the cutting equipment improves the productivity of the cutting systems with a single cutting saw with a single cutting edge and, therefore, with a single cutting direction and the need to make unproductive displacements of the product to be cut, solving this with the two cutting directions that are possible in the present invention, by having the cutting edges of each of the opposite band saws, on the external parts of each band saw, the external part of each of them being considered as the farthest edge from the other band saw.

In the same way, this new configuration solves the problem of single band saws with two serrated cutting edges that, allowing cutting in two directions, prevent their subjection to pressures in the same cutting plane, having malfunction problems, which are minimised with this configuration of two band saws per cutting system, with their corresponding guide and separation pieces that act to retain the possible displacement of the band saws when the product to be cut is pressed on them, thus being able, for example, to cut frozen food products, as well as non-frozen products, whether or not they have bone in them.

### BRIEF DESCRIPTION OF THE DRAWINGS

In order to better understand the description made, a set of drawings has been provided which, schematically and solely by way of non-limiting example, represents a practical case of embodiment.

FIG. 1 is an elevational view of the cutting equipment in a view perpendicular to the cutting plane.

FIG. 2 is an elevational view of the cutting mechanism through the cutting plane.

FIG. 3 is a perspective view of the band saw guide piece.

FIG. 4 is a perspective view of the detail of the location of the top guide pieces and the protection associated with the equipment.

FIG. 5 is a detailed perspective view of the location of the lower guide pieces.

FIG. 6 is a perspective view of the cleaning element detail of band saws.

### DESCRIPTION OF A PREFERRED EMBODIMENT

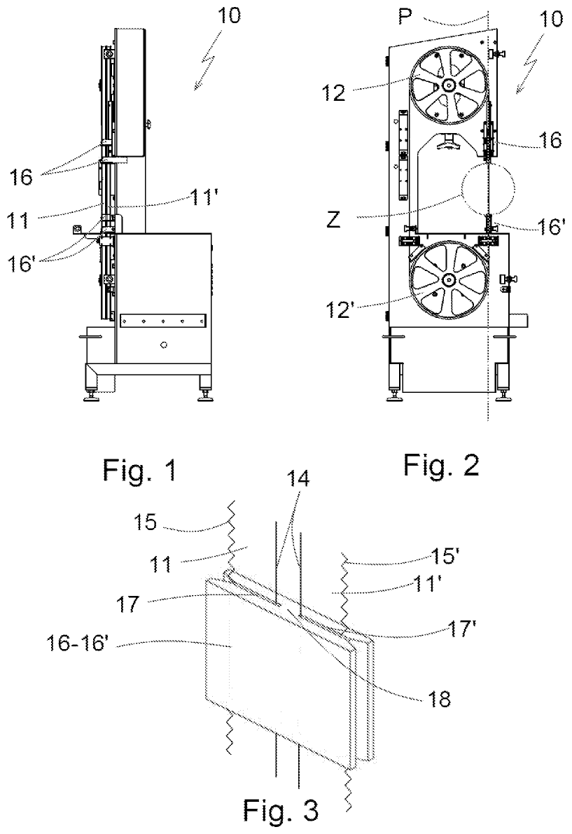

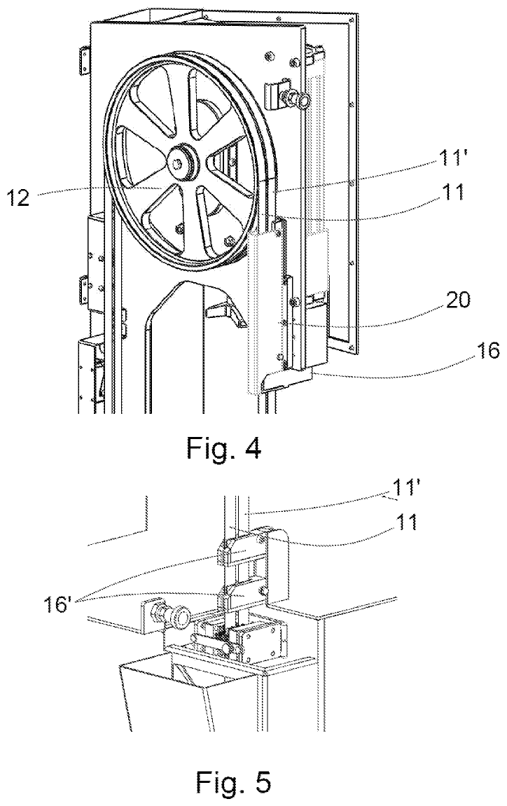

In the present preferred embodiment of the invention, and as shown in FIGS. 1 to 6, the products cutting equipment (10) by band saw, in this case frozen food products, is based on a cutting system that has two individual band saws (11, 11′), contiguous without touching each other, having such band saws (11, 11′) in the same cutting plane (P), mounted on the same pulley wheel (12) with double channel/rail, where alternatively, they could be mounted on a double pulley wheel system with a single channel/rail each of them, being able to be independent pulley systems mounted jointly, with this separation between band saws (11, 11′).

The band saws (11, 11′) are characterised in that they have a single cutting edge (15), being positioned in such a way that the inner edges (14) do not have cutting serrated edges, but the opposite outer edges (15) are serrated to have the possibility of cutting and, in this way, it is possible to pass the product to be cut in one direction or in another indifferently, and the product can be cut in both directions, not having to make an extra displacement of the product to the beginning of the equipment to make the cut in the same direction. The outer edge (15) is the part of the band saw furthest from the other band saw, while the inner edges (14) are the closest edges between them of each band saw (11, 11′).

These band saws (11, 11′) are preferably separated by a distance of less than 6 mm, preferably 4 mm to 5 mm, which is achieved in the first instance by the separation between the channels/rails of the pulley wheel (12). In alternative embodiments, minimum separations of 2 mm are reached to avoid risks of contacts between saws (11, 11′). By introducing auxiliary elements such as cut product separators or the like, superior separations could be achieved.

Alternatively, these band saws (11, 11′) can be separated by a distance of less than 8 mm. Alternatively, they can be separated by 6 mm to 4 mm, as mentioned above, which is achieved in the first instance by the separation between the channels/rails of the pulley wheel (12).

As the band saws (11, 11′) are subjected to a pressure caused by the passage of the product to be cut on these band saws (11, 11′), these (11, 11′), although they are tensioned to make their rotation between the pulleys (12) and avoid varying their cutting plane, they may tend to move in the same cutting plane in the same direction of advance of the product to be cut by its pressure against them, which could cause the pulley rail/channel (12) to come off or impact the first band saw (11) to make the cut against the adjacent band saw (11) and cause them to contact each other, which could result in damage to the band saws (11, 11′). In the same way, the cutting friction of the band saws (11, 11′) on the product can cause perpendicular forces to the cutting plane, depending on the material to be cut, which can cause cuts of non-regular thickness.

The cutting equipment (10) includes, in the present embodiment, two pairs of guide and separation pieces (16, 16′) fixed to the cutting equipment (10) that define between each pair (16, 16′) a cutting area (Z), guiding the passage through these pairs of pieces (16, 16′) of each of the band saws (11, 11′) to minimise variations in the cutting plane between these two pairs of pieces (16, 16′) and physically separating them in such a way that although there is such pressure, they do not come into contact with each other (11, 11′).

As an alternative to this and other possible embodiments, it is possible to have a single pair of guide and separation pieces, one piece on each side of the cutting area, or a single guide and separation piece in the cutting system that performs this function in the area next to the cut, preferably. More guide pieces are also available depending on the configuration of the required cutting area and the expected cutting resistance characteristics of the product, preferably grouped in pairs on either side of the cutting area.

Each of the guiding and separation pieces (16, 16′), as can be seen in FIG. 3, consists of a body which, in the present embodiment, has at least tungsten carbide, having a high resistance to wear, in such a way that materials with a similar resistance to wear could be used in the same way, such as thermal plastics with graphite, ceramic materials, fibres or other special plastics. This piece of guidance and separation has a groove (17), as a guidance element, for each of the passages to guide each band saw (11, 11′), with dimensions slightly higher than the thickness and width of these band saws (11, 11′) in such a way that pressures against them that are in the plane perpendicular to the cutting, are prevented by such guidance by the grooves. In the same piece there is a separation (18) between the grooves (17), as a separation element, which corresponds to the minimum separation desired between the two band saws (11, 11′) and avoids the displacement of the band saw (11, 11′) that receives the pressure of the product when making the cut, in the cutting plane in the cutting direction.

In the case of alternative designs, the guide and separation piece can be kept in separate guide and separation bodies instead of in one piece.

Alternatively, the guide and separation piece can be made with bearings, not shown in the figures, instead of contact surfaces of the tungsten carbide body, based on a pair of facing bearings, as a guiding element, which leave a gap between them slightly greater than the width of the band saw (11, 11′), and as a separation element for the guide and separation piece, one or more bearings between the two band saws (11, 11′) would be used to maintain a minimum distance between these saws (11, 11′).

In the present embodiment, there is an upper guide and separation piece (16) that can be adjusted in height, in order to define a cutting zone (C) variable between the two guide and separation pieces (16, 16), where the lower piece (16′) is fixed close to the platform where the product to be cut is moved.

Alternatively, the guiding and separating pieces can all be fixed or adjustable, all of them, to have different configurations of the cutting equipment (10).

The cutting equipment (10), in the present embodiment of use in automatic mode by means of the movement of the product by an automated grip and movement device, includes a protective system (20) of the band saws (11, 11′) with automatic movement at the moment in which the entry of an operator is detected in the associated safety enclosure of the cutting equipment. This protective system (20) is formed by an enclosing structure of these band saws (11, 11′), which when detecting the entry of the person in the safety area, moves this structure to the cutting area, minimising the possibility of damage if there was a break in these band saws (11, 11′) and preventing that by accident an operator could access the cutting area.

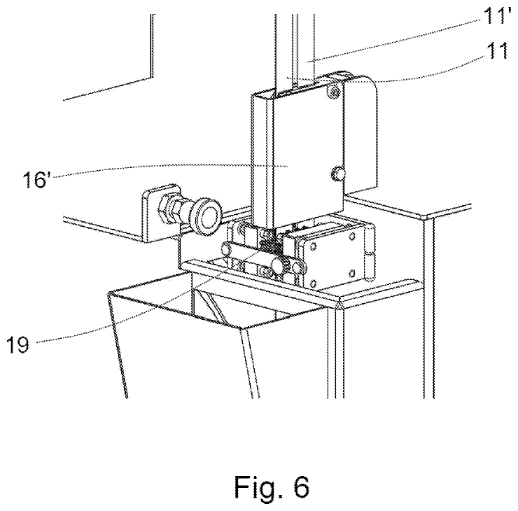

As another auxiliary element, and as can be seen in FIG. 6, the cutting equipment (10) includes a band saw cleaning system (19), where this cleaning system (19) is formed by the action of brushes that are beside and on the side of the band saw (11, 11′) and having an elastic system in such a way that, as the brush is used, it is supplied, bringing it closer to the band saw (11, 11′) and in such a way that any impact/contact on the said brush by the band saw (11, 11′) is absorbed by the elastic system, preferably springs.

As an alternative configuration that would include the previous elements of the main accomplishment commented and its commented alternatives, the cutting equipment (10) has two or more cutting systems that make cuts in parallel planes, for the same passage of the product, that can make several cuts at the same time.

Although reference has been made to a specific embodiment of the invention, it is clear to a person skilled in the art that the band saw cutting equipment is susceptible to numerous variations and modifications, and that all the details mentioned can be replaced by others technically equivalent, without departing from the scope of protection defined by the attached claims.

1. A band saw cutting equipment which has a pulley system in which the band saw cutting system is installed, wherein the cutting equipment contains at least one cutting system made up of two band saws located in the same cutting plane contiguously without touching each other, with a separation between them, each of the two band saws having a single side with cutting serrated edges located on the farthest edges between the two band saws, i.e. in their opposite edges to allow cutting in both directions of passage through the cutting system, characterized in that the cutting system has at least one guide and separation piece of both band saws fixed in a position that guides each of the band saws in the cutting plane, preventing it from bending and exiting from that plane by means of guiding elements and keeping both band saws separated in the cutting plane by means of a minimum separation element.

2. The band saw cutting equipment in accordance with claim 1, wherein the guiding element of the guide piece and separation of each band saw is based on a body with a groove slightly wider than that of the band saw, through which the band saw passes.

3. The band saw cutting equipment in accordance with claim 1, wherein the separation element of the guiding and separating piece is based on a body between the two guiding grooves of band saws that maintain a minimum distance between these saws.

4. The band saw cutting equipment in accordance with claim 1, wherein the guiding elements for each band saw and the separating element are contained in the same guiding and separating body through which the band saws pass.

5. The band saw Band saw cutting equipment in accordance with claim 1, wherein the body forming the guiding element and the separating element is comprised of at least tungsten carbide.

6. The band saw cutting equipment in accordance with claim 1, where the guiding element of the guiding and separation piece is based on at least one pair of facing bearings that leave a gap between them slightly wider than the width of the band saw, and the separating element of the guiding and separation piece is based on bearings between both band saws that maintain a minimum distance between these saws.

7. The band saw cutting equipment in accordance with claim 1, wherein the minimum separation between the two band saws located in the same cutting plane achieved by the dimension of the separating element is less than 30 mm.

8. The band saw cutting equipment in accordance with claim 7, wherein the minimum separation between the two band saws located in the same cutting plane achieved by the dimension of the separating element is between 2 mm and 6 mm.

9. The band saw cutting equipment in accordance with claim 1, wherein the cutting equipment has at least two pieces of guidance and separation of both band saws, each of them being located on each side of the cutting area of the product.

10. The band saw cutting equipment in accordance with claim 1, wherein the cutting equipment has at least one pair of guiding and separating pieces of both band saws, each pair being located on each side of the cutting area of the product.

11. The band saw cutting equipment in accordance with claim 9, wherein at least one of the two guiding and separating pieces or one of the pairs of guiding and separating pieces located on either side of the cutting area can regulate the height of its position.

12. The band saw cutting equipment in accordance with claim 1, wherein the cutting equipment has a system of pulleys with double channel/rail, installing each of the band saws in each channel/rail.

13. The band saw cutting equipment in accordance with claim 1, wherein the cutting equipment has a system of pulleys with a double pulley wheel, installing each of the band saws on individual pulley wheels.

14. The band saw cutting equipment in accordance with claim 1, wherein the cutting equipment has a band saw protection system formed by a band saw enclosing structure that automatically moves to cover the cutting area.

15. The band saw cutting equipment in accordance with claim 1, wherein the cutting equipment has a cleaning system for band saws.

16. The band saw cutting equipment in accordance with claim 15, wherein the cleaning system of band saws is formed by brushes beside and on the side of the band saws with an elastic system of approach to the band saw and absorption of contacts with these band saws.

17. The band saw cutting equipment in accordance with claim 1, wherein the cutting equipment has two or more cutting systems that make cuts in parallel planes.
